(19) United States
(12) Patent Application Publication
(10) Pub. No.: US 2013/0179480 A1
(43) Pub. Date: Jul. 11, 2013

(54) SYSTEM AND METHOD FOR OPERATING A CLUSTERED FILE SYSTEM USING A STANDALONE OPERATION LOG

(71) Applicant: STEC, INC., Santa Ana, CA (US)

(72) Inventors: Anurag AGARWAL, Pune (IN); Anand MITRA, Pune (IN)

(73) Assignee: STEC, INC., Santa Ana, CA (US)

(21) Appl. No.: 13/689,112

(22) Filed: Nov. 29, 2012

Related U.S. Application Data
(60) Provisional application No. 61/583,466, filed on Jan. 5, 2012.

(51) Int. Cl. G06F 17/30

(52) U.S. Cl. CPC G06F 17/30115
USPC 707/822

(57) ABSTRACT

Systems and methods are disclosed for operating a clustered file system using an operation log for a file system intended for standalone computers. A method for updating a file stored in a clustered file system using a file system intended for standalone computers includes receiving a command to update a file, writing the command to update the file to an operation log on a file system on a primary node, where the operation log tracks changes to one or more files, transmitting the updated operation log to a secondary node to initiate performance of the received command by the secondary node, and applying the requested changes to the file on the primary node.

### CROSS-REFERENCE TO RELATED APPLICATIONS

This application claims benefit under 35 U.S.C. §119(e) of U.S. Provisional Patent Application No. 61/583,466, entitled “System and Method for Creating a Clustered File System Using a Standalone Operation Log,” filed Jan. 5, 2012, which is expressly incorporated herein by reference in its entirety.

### FIELD OF THE DISCLOSURE

The present disclosure relates generally to clustered file systems for computer clusters and specifically to operating a clustered file system using a standalone operation log.

### BACKGROUND

A file system generally allows for organization of computer files by defining user-friendly abstractions including file names, file metadata, file security, and file hierarchies. Example file hierarchies include partitions, drives, folders, and directories. Specific operating systems support specific file systems. For example, DOS (Disk Operating System) and MICROSOFT® WINDOWS® support File Allocation Table (FAT), FAT with 16-bit addresses (FAT16), FAT with 32-bit addresses (FAT32), New Technology File System (NTFS), and Extended FAT (ExFAT). MACINTOSH® OS X® supports Hierarchical File System Plus (HFS+). LINUX® and UNIX® support second, third, and fourth extended file system (ext2, ext3, ext4), XFS, Journaled File System (JFS), ReiserFS, and B-tree file system (btrfs). Solaris supports UNIX® File System (UFS), Veritas File System (VxFS), Quick File System (QFS), and Zettabyte File System (ZFS).

ZFS (zettabyte file system) is a file system for standalone computers that supports features such as data integrity, high storage capacities, snapshots, and copy-on-write clones. A ZFS file system can store up to 256 quadrillion zettabytes (ZB), where a zettabyte is 2⁷⁰ bytes. When a computer running ZFS receives an instruction to update file data or file metadata on the file system, then that operation is logged in a ZFS Intent Log (ZIL).

The operating system flushes or commits the ZIL to storage when the node executes a sync operation. A flush or commit operation refers to applying the operations described in the log to the file contents in storage. The ZIL operation is similar to the commands sync( ) or fsync( ) found in the UNIX® family of operating systems. The sync( ) and fsync( ) commands write data buffered in temporary memory or cache to persistent storage.

ZIL logging is one specific implementation of operation logging generally. Computer programs use UNIX® file system operations such as the sync( ) or fsync( ) commands to store, or commit, entries in the ZIL to disk. The ZIL provides a high-performance method of commits to storage. Accordingly, ZFS provides a replay operation, whereby the file system examines the operation log and replays uncommitted system calls.

ZFS supports replaying the ZIL during file system recovery, for example if the file system becomes corrupt. This feature allows the standalone computer to reconstruct a stable state after system corruption or a crash. By replaying all file system operations captured in the log since the last stable snapshot, the standalone computer can restore stability by applying the operations described in the operation log.

The description above has described file systems in use on standalone computers. In contrast to a standalone computer, a cluster is a group of linked computers, configured so that the group appears to form a single computer. Each linked computer in the cluster is referred to as a node. The nodes in a cluster are commonly connected through networks. Clusters exhibit multiple advantages over standalone computers. These advantages include improved performance and availability, and reduced cost.

One benefit of using a clustered file system is that it provides a single coherent and cohesive view of a file system that exhibits high availability and scalability for file operations such as creating files, reading files, saving files, moving files, or deleting files. Another benefit is that, compared to a standalone file system, a clustered file system allows for the file system to be consistent and serializable. Consistency refers to the clustered file system providing the same data no matter which node is servicing a request in the case of concurrent read accesses from multiple nodes in a cluster. Serializability refers to ordering concurrent write requests so that the file contents of each node are the same across nodes.

### SUMMARY

In one aspect, the present disclosure provides a method for updating a file stored in a clustered file system using a file system intended for standalone computers, the method including receiving a command to update a file, writing the command to update the file to an operation log on a file system on a primary node, where the operation log tracks changes to one or more files, transmitting the updated operation log to a secondary node to initiate performance of the received command by the secondary node, and applying the requested changes to the file on the primary node.

In one aspect, the present disclosure also provides a computer cluster including an interface connecting a primary node and a secondary node, where each node is configured with a file system intended for standalone computers, a primary node including a first storage medium configured to store files and to store a first operation log, where the operation log tracks changes to one or more of the files, and a processing unit configured to receive a command to update a file, write the command to update the file to the operation log, transmit the updated operation log to a secondary node to initiate performance of the received command by the secondary node, and apply the requested changes to the file, and the secondary node including a second storage medium configured to store files and to store a second operation log, and a processing unit configured to receive an operation log from the primary node, and apply the requested changes to the file.

In one aspect, the present disclosure also provides a non-transitory computer program product, tangibly embodied in a computer-readable medium, the computer program product including instructions operable to cause a data processing apparatus to receive a command to update a file, write the command to update the file to an operation log on a file system on a primary node, where the operation log tracks changes to one or more files, transmit the updated operation log to a secondary node to initiate performance of the received command by the secondary node, and apply the requested changes to the file on the primary node.

In one aspect, the present disclosure also provides a plurality of computer clusters comprising an interface connecting a plurality of computers, where the computers are configured as nodes in a plurality of computer clusters, each computer in the plurality of computers including a storage medium configured with a plurality of file systems to store files and to store an operation log, where the operation log tracks changes to one or more of the files, and a processing unit configured to receive a command to update a file, if the computer is configured as a primary node, write the command to update the file to the operation log, transmit the updated operation log to a secondary node to initiate performance of the received command by the secondary node, and apply the requested changes to the file, otherwise, receive an operation log from the primary node, and apply the requested changes to the file.

In some embodiments, the command to update the file includes a command to write a new file. In some embodiments, the file system includes at least one of a zettabyte file system (ZFS) and a Write Anywhere File Layout (WAFL). In some embodiments, the primary and secondary nodes have different configurations of a plurality of storage devices. In some further embodiments, the configurations of the plurality of storage devices include ZFS storage pools (zpools).

### BRIEF DESCRIPTION OF THE DRAWINGS

Various objects, features, and advantages of the present disclosure can be more fully appreciated with reference to the following detailed description when considered in connection with the following drawings, in which like reference numerals identify like elements. The following drawings are for the purpose of illustration only and are not intended to be limiting of the invention, the scope of which is set forth in the claims that follow.

FIG. 1 illustrates a block diagram of a system for operating a clustered file system using a standalone operation log in accordance with some embodiments of the present disclosure.

FIG. 2 illustrates a flow diagram of a method for performing an update command on a clustered file system using a standalone operation log in accordance with some embodiments of the present disclosure.

FIG. 3 illustrates a flow diagram of a method for performing a read command on a clustered file system using a standalone operation log in accordance with some embodiments of the present disclosure.

FIGS. 4A-4B illustrate block diagrams of a system for operating multiple clustered file systems using standalone operation logs in accordance with some embodiments of the present disclosure.

### DETAILED DESCRIPTION

The present disclosure relates to a system and method for implementing a clustered file system on a cluster of computers, by using an operation log from a standalone computer file system. The present system and method implement a clustered file system by receiving a request to update a file, and transmitting a copy of the operation log from a primary node to a secondary node of a computer cluster, which initiates replaying the operation log on the secondary node to perform the same requested updates as performed on the primary node.

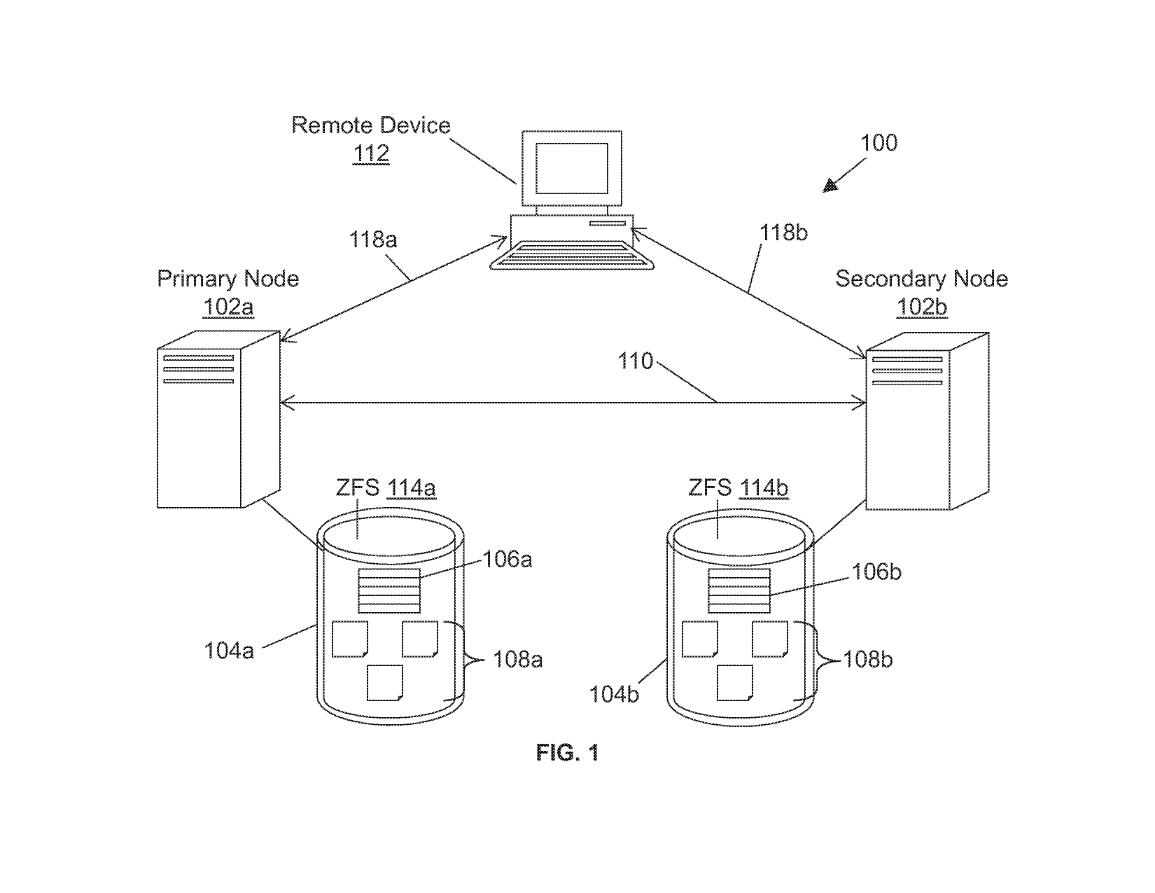

FIG. 1 illustrates a block diagram of a system 100 for operating a clustered file system using a standalone operation log in accordance with some embodiments of the present disclosure. The present system includes a remote device 112 in communication with a primary node 102a and a secondary node 102b. Primary and secondary nodes 102a, 102b include standalone storage 104a, 104b. Standalone storage 104a, 104b uses ZFS file systems 114a, 114b with corresponding operation logs 106a, 106b and files 108a, 108b. Primary and secondary nodes 102a, 102b are in communication using interface 110.

Some embodiments of the present disclosure can be configured with two computers as primary and secondary nodes 102a, 102b in a cluster and connected via interface 110. In some embodiments, interface 110 can be a network. In some embodiments, interface 110 can be a high speed network such as INFINIBAND® or 10 Gbps Ethernet. Although interface 110 is illustrated as a single network, it can be one or more networks. Interface 110 can establish a computing cloud (e.g., the nodes and storage devices are hosted by a cloud provider and exist “in the cloud”). Moreover, interface 110 can be a combination of public and/or private networks, which can include any combination of the internet and intranet systems that allow remote device 112 to access storage 104a, 104b using primary node 102a and secondary node 102b. For example, interface 110 can connect one or more of the system components using the Internet, a local area network (“LAN”) such as Ethernet or Wi-Fi, or wide area network (“WAN”) such as LAN to LAN via internet tunneling, or a combination thereof, using electrical cable such as HomePNA or power line communication, optical fiber, or radio waves such as wireless LAN, to transmit data.

One computer can be designated as primary node 102a, and the other computer can be designated as secondary node 102b. Each computer is configured with the ZFS standalone file system 114a, 114b. The computers each can have their own independent storage 104a, 104b, of equal overall storage capacity. Both nodes 102a, 102b can provide the same file system name space, which refers to a consistent naming and access system for files. Each primary and secondary node 102a, 102b can have its own storage media, with a complete set of files 108a, 108b stored locally. In some embodiments, example storage media can include hard drives, solid state devices using flash memory, or redundant storage configurations such as Redundant Array of Independent Disks (RAID). Files 108a, 108b on storage 104a, 104b are duplicates of each other so that every file is available on each node.

While the present disclosure describes example embodiments using a two node cluster setup, one of skill in the art will recognize that this configuration can be easily extended to more than two nodes, for example, one primary node and a plurality of secondary nodes.

In some embodiments, the present system and method does not require that both nodes have the same individual configuration of storage. In contrast, other clustered file system configurations can require each node to have exactly duplicated storage configurations. For example, in the present system primary and secondary nodes 102a, 102b could each be configured with a total of 1 terabyte of storage. Primary node 102a could have a single hard drive with 1 terabyte capacity. Secondary node 102b could have two solid state devices each with 500 gigabyte capacity.

Transmission of ZIL

In some embodiments, the present system operates a clustered file system by transmitting a copy of the ZIL from primary node 102a to secondary node 102b, and replaying the ZIL on secondary node 102b. The present system and method supports two types of file system operations: (1) update operations and (2) read operations. Update operations can create or change the contents of a requested file. Read operations can fetch the contents of a requested file. While the present disclosure describes update and read operations, the present system can be used to operate a clustered file system for generally any other file operations supported by the underlying standalone file system. For example, create, move, and delete file operations can be supported by the present system and method by transmitting the ZIL.

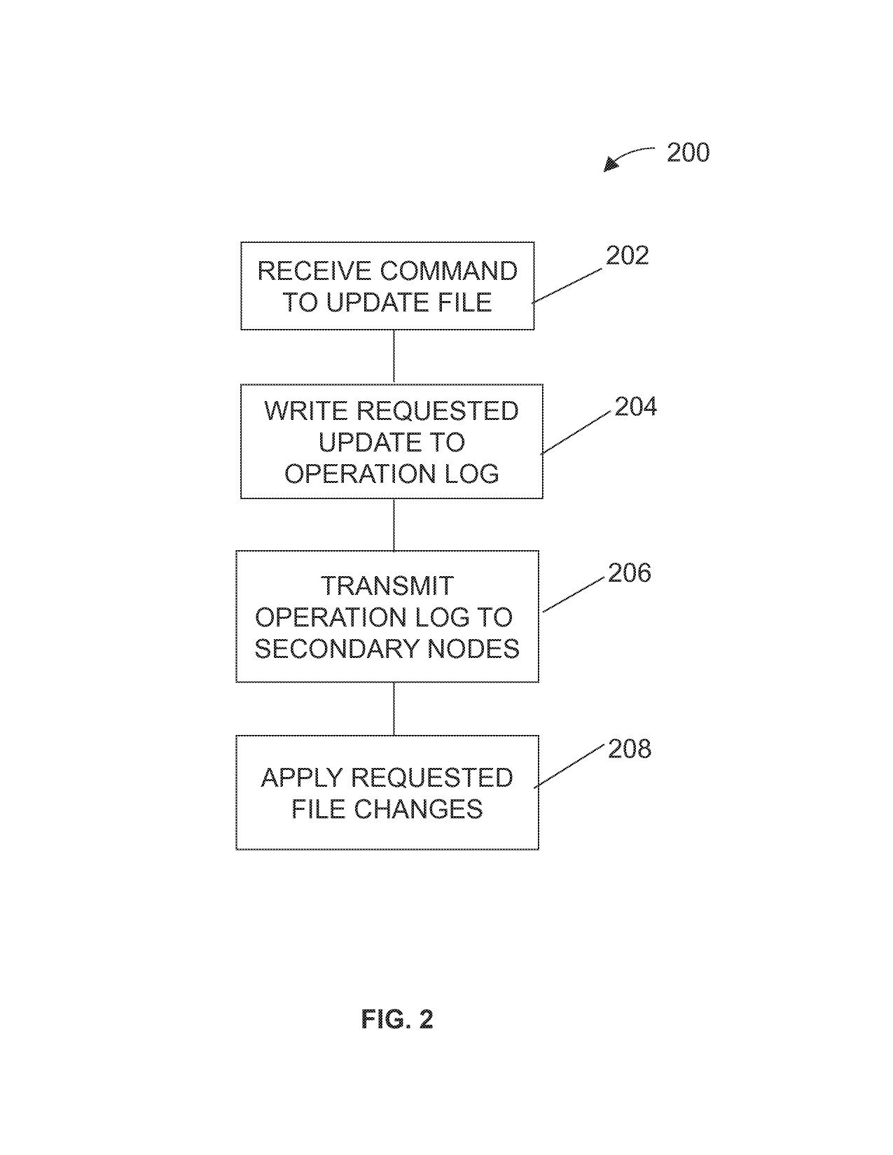

FIG. 2 illustrates a flow diagram of a method 200 for performing an update command on a clustered file system using a standalone operation log in accordance with some embodiments of the present disclosure. In some embodiments, the present system performs update file operations as follows. The primary node receives a command to update a file (step 202). The update file command can specify a file to be updated, and new data, contents, or metadata with which to update the file. The primary node can receive the command from the remote computer. As used in the operating system, the update file operation request also can be referred to as a sync( ) or fsync( ) operation to write data to storage attached to the primary node or to the secondary node. Upon receiving the update file command, the primary node writes the requested file system transaction to the operation log of the file system (step 204). When the operation log is written to the file system on the primary node, the present system copies the operation log over the interface to the secondary nodes (step 206).

In some embodiments, the transmission of the operation log can occur synchronously or asynchronously. Generally, the remote system or the primary node can transmit the operation log asynchronously. Asynchronous transmission initiates updates to files and directories on the clustered file system automatically. The present system also can transmit the ZIL synchronously, in response to a command from the remote computer. For example, if the ZIL is committed to disk as part of a sync( ) or fsync( ) operation, then the remote system or the primary node can transmit the operation log synchronously.

Transmitting a copy of the operation log initiates replaying the operation log on the secondary nodes. This replay operation copies the changes on the secondary nodes that the primary node will apply to its file system. The primary node applies the requested file changes to its file system (step 208). Accordingly, the replay operation results in the secondary nodes applying the same updates in the same order that the primary node applies. The primary node and the secondary nodes have substantially the same file system state before transmission of the operation log. Because the secondary nodes replay the file system operations in the order governed by the operation log, upon completion of the replay of the operation log, the primary node and the secondary nodes have the same file system state with the new changes applied.

Accordingly, both nodes provide a consistent representation of the clustered file system before and after the update file operation. A consistent representation of the clustered file system means that files read from one node are the same as files read from another node. This consistency is important for data integrity. Otherwise, if an update file operation did not update each node of a clustered file system properly, subsequent read commands of the file might return incorrect or stale data from some nodes, and correct updated data from other nodes.

In some embodiments, either the remote system or the primary node can transmit the copy of the operation log. If the remote system transmits the copy of the operation log to the secondary nodes, the remote system can coordinate with the primary node and secondary nodes to preserve the order of requested file changes across the primary and secondary nodes, so that the secondary nodes can apply the same updates in the same order that the primary node applies. As described earlier, upon completion of the replay of the operation log, the primary node and the secondary nodes have the same file system state with the new changes applied.

In some embodiments, the present method and system support locking of objects in the file system. During the update file operation described earlier, one risk is that the secondary node might receive additional requested file system operations from the remote computer while an initial update file system operation is in progress. To alleviate this issue, the secondary node can lock objects in its file system while performing the requested update. In particular, the secondary node can use existing ZFS functionality for providing local locks on individual files or objects. Accordingly, the secondary node does not fulfill waiting file system operations on individual files until the operation log has finished replaying on the secondary node. This locking avoids concurrent file system accesses to individual files by ensuring that the secondary node has incorporated all file system updates to individual files from the primary node, prior to servicing pending file system requests. In the present system, locking is implemented because the underlying sync( ) operation does not indicate successful completion until new entries in the ZIL of the primary node are copied to the secondary node. On a standalone ZFS configuration, the ZIL provides a sequential or serial order to update file operations. The present system leverages this sequential order from standalone computer configurations, to ensure that the same set of operations is performed in the same order on both nodes of a computer cluster, and therefore both file systems are in a consistent state.

Unlike other clustered file system implementations, the present system avoids complicated synchronization mechanisms to ensure file integrity. Other clustered file systems can ensure file integrity using global cluster-wide locking of file system buffers or file system metadata referred to as inodes. As described earlier, instead of global locking across all nodes of a cluster, the present system provides file integrity through local transmission of the ZIL and local locking of individual files in the file system of the secondary node during update file operations.

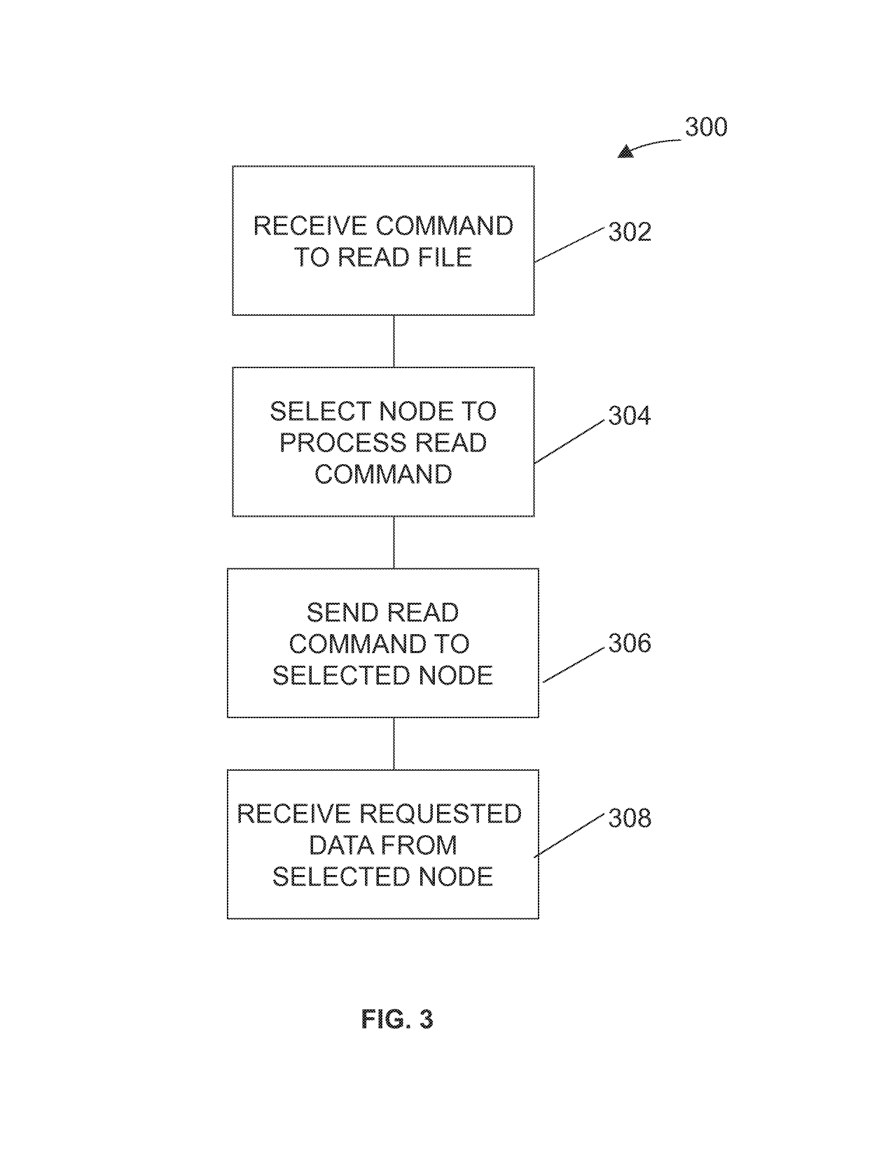

FIG. 3 illustrates a flow diagram of a method 300 for performing a read command on a clustered file system using a standalone operation log in accordance with some embodiments of the present disclosure. As described earlier, the present system supports read file operations in addition to update file operations. The remote computer receives a command to read a file (step 302). The remote computer can receive the command from another computer, or the remote computer can initiate the command. The remote computer selects a node to process the read command (step 304). In some embodiments, the remote computer can select the node based on which node is the least busy. Alternatively, the remote computer can always select the primary node, or the remote computer can always select the secondary node. The remote computer sends the read command to the selected node (step 306). The remote computer then receives the requested data or contents stored in the file on the selected node (step 308). The present system improves performance because the remote computer is not required to wait for a node that can be busy with other tasks. Instead, the remote computer can select another node with availability to respond to the read file operation request. The present system implements a loose clustering model, which refers to the ability of any node in the cluster to service requests as described earlier.

Furthermore, the present system leverages use of an operation log instead of a metadata log. This flexibility provides for improved ease of administration and configuration compared to other clustered file systems. In some embodiments, the primary and secondary nodes support individual storage configurations, so long as the primary and secondary nodes are configured with the same overall total storage capacity. This support for individual storage configurations is provided because the ZIL is an operation log and not a metadata log. An operation log refers to a log which specifies the underlying system operations to be performed on files. When the ZIL is copied to a secondary node, the ZIL describes the underlying system operations to be performed by ZFS, such as allocating free space or updating file contents. For example, the ZIL can describe an update command, the updated data to be written, and an offset and length of the data. In comparison, a metadata log refers to a log which describes the actual metadata corresponding with a given file, such as particular blocks being allocated and block map changes corresponding to the actual data blocks being updated. Other example metadata can include particular block numbers or specific inode indices for storing file contents. When individual primary and secondary nodes have differing individual storage configurations, the file metadata stored on one node can be incompatible with the other nodes. If a metadata log from a primary node were copied to a secondary node having a different individual storage configuration, the metadata might become corrupted or lost because of incompatibilities. Accordingly, for other clustered file systems to avoid metadata corruption, the individual storage configurations of each node are required to be identical. Because the present system uses an operation log to implement a clustered file system, the individual storage configuration of each primary and secondary node can be different while still preserving file metadata. Systems which support an operation log include the ZFS (zettabyte file system) as described earlier, and the Write Anywhere File Layout (WAFL).

In some embodiments, the individual storage configuration includes configuring each node with a different ZFS storage pool (hereinafter “zpool”). Support for different zpools is one example of how each node can be configured with the same overall storage capacity but with different individual storage configurations. A zpool is used on standalone computers as a virtual storage pool constructed of virtual devices. ZFS virtual devices, or vdevs, can themselves be constructed of block-level devices. Example block-level devices include hard drive partitions or entire hard drives, and solid state drive partitions or entire drives. A standalone computer's zpool represents a particular storage configuration and related storage capacity.

Zpools allow for the advantage of flexibility in storage configuration partly because composition of the zpool can consist of ad-hoc, heterogeneous collections of storage devices. On a standalone computer, ZFS seamlessly pools together these ad-hoc devices into an overall storage capacity. For example, each node in a clustered file system can be configured with one terabyte of total storage. The primary node can be configured with a zpool of two hard drives, each with 500 gigabyte capacity. The secondary node can be configured with a zpool of four solid state drives, each with 250 gigabyte capacity. Unlike with some other clustered file systems, the individual storage configuration of each node does not need to be duplicated. Furthermore, administrators can add arbitrary storage devices and device types to existing zpools to expand their overall storage capacities at any time. For example, an administrator might increase the available storage of the zpool in the primary node described earlier by adding a storage area network (SAN), even though the existing zpool is configured using hard drives. Support for arbitrary storage devices and device types means that administrators are freer to expand and configure storage dynamically, without being tied to restrictive storage requirements associated with other clustered file systems.

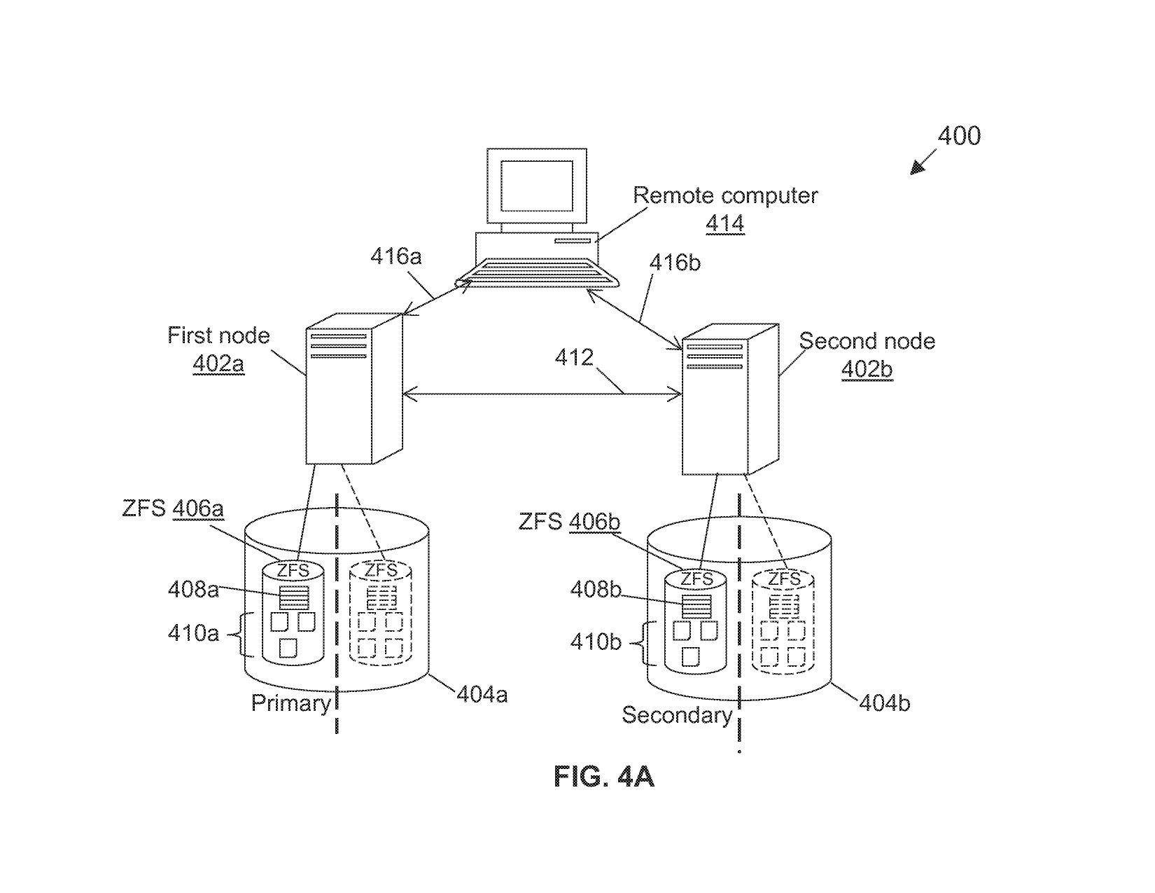

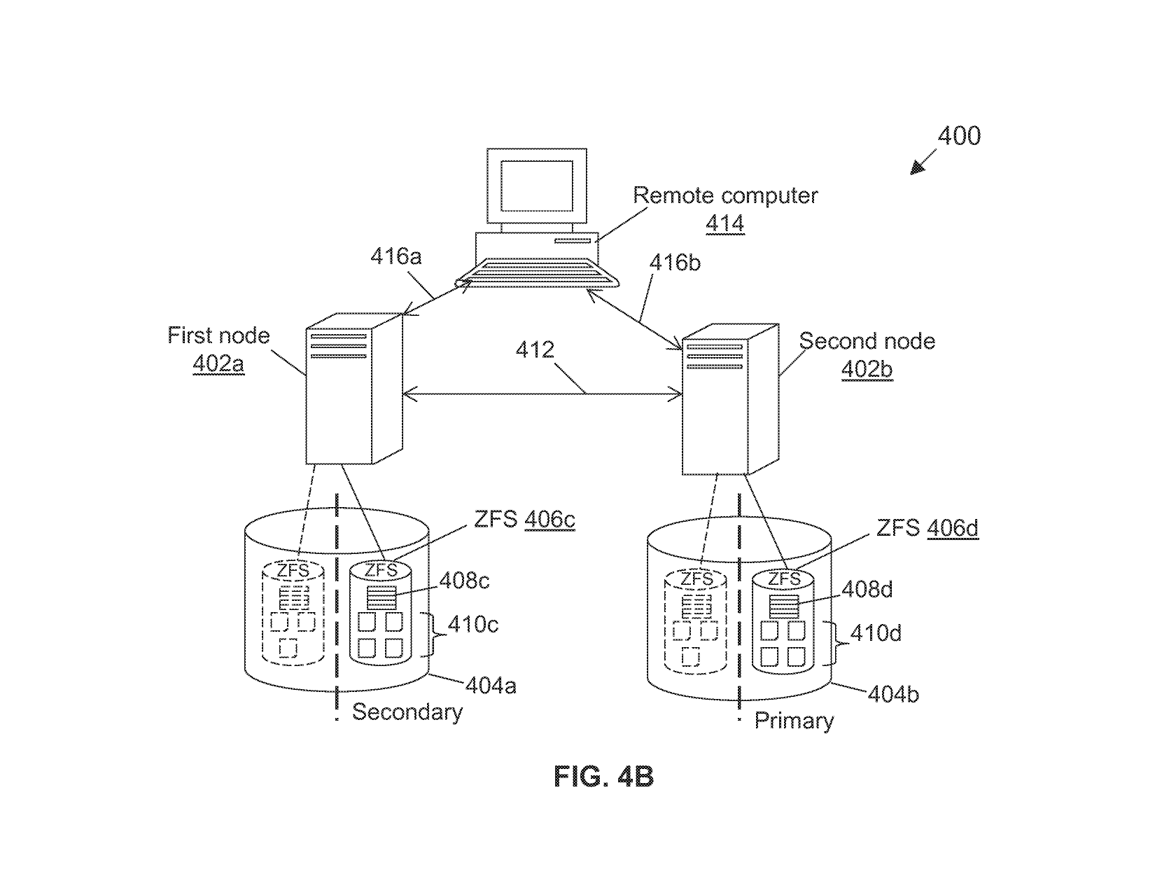

FIGS. 4A-4B illustrate a block diagram of a system 400 for operating multiple clustered file systems using standalone operation logs in accordance with some embodiments of the present disclosure. In some embodiments, the present system includes nodes which can divide their storage to provide multiple file systems, and which can appear to one cluster as a secondary node, while appearing to a second cluster as a primary node. FIGS. 4A and 4B illustrate one such example in which the nodes have storage pools with multiple ZFS file systems.

FIG. 4A includes a remote computer 414 in communication with a first cluster over interfaces 416a, 416b. The first cluster includes a first node 402a and a second node 402b in communication over interface 412. First node 402a includes a first storage pool 404a, and second node 402b includes a second storage pool 404b. First storage pool 404a includes a first ZFS file system 406a. First ZFS file system 406a includes a first operation log 408a and a first set of files 410a. Second storage pool 404b includes a second ZFS file system 406b with a second operation log 408b and a second set of files 410b.

As illustrated in FIG. 4A, first node 402a is configured as the primary node in the first cluster using first ZFS file system 406a. First ZFS file system 406a uses first operation log 408a and corresponding files 410a. When an update command or a read command arrives to or is initiated by remote computer 414 for the first cluster, remote computer 414 processes the request as described earlier. For example, for an update command, remote computer 414 or first node 402a can transmit a copy of first operation log 406a using interface 412 to second node 402b configured as the secondary node using ZFS file system 406b. The result of completing the update command is that corresponding files 410b are identical to files 410a on the primary node.

FIG. 4B illustrates a simultaneous second cluster using first and second nodes 402a, 402b. For the second cluster, the roles of first and second nodes 402a, 402b can be reversed. The second cluster includes remote computer 414 in communication with the second cluster over interfaces 416a, 416b. The second cluster includes first and second nodes 402a, 402b in communication over interface 412. As described earlier, first node 402a includes first storage pool 404a, and second node 402b includes second storage pool 404b. To support the second cluster, first storage pool 404a is configured with a third ZFS file system 406c, and second storage pool 404b is configured with a fourth ZFS file system 406d. Third ZFS file system 406c includes a third operation log 408c and a third set of files 410c. Fourth ZFS file system 406d includes a fourth operation log 408d and a fourth set of files 410d. In the second cluster, second node 402b is configured as a primary node using fourth ZFS file system 406d.

Similar to the operations described earlier for the first cluster, the second cluster can respond to update commands and read commands. In response to an update command, remote computer 414 can transmit a copy of the operation log from the primary node to the secondary node using interface 412. In this example, second node 402b is acting as a primary node and first node 402a is acting as a secondary node. Accordingly, the present system copies fourth operation log 408d from second node 402b, acting as the primary node, to first node 402a, acting as the secondary node. After the update operation, files 410d are updated on the second node 402b, acting as the primary node, and are consistent with files 410c updated on the first node 402a, acting as the secondary node. Accordingly, in embodiments in which each node is configured with multiple file systems, the node can be configured for a first cluster as a secondary node, and the same node can be configured for a second cluster as a primary node, at the same time.

In other embodiments, a computer with multiple file systems can act as a clustered node and as a standalone computer, at the same time. A node's storage pool can be configured with multiple ZFS file systems as illustrated in FIGS. 4A, 4B. One ZFS file system can be used as a clustered file system, as described earlier. The other ZFS file system can be used as a standalone file system in the same storage pool. This embodiment allows an administrator to receive the benefits of a clustered file system and of a standalone computer using the same hardware.

Those of skill in the art would appreciate that the various illustrations in the specification and drawings described herein can be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware, software, or a combination depends upon the particular application and design constraints imposed on the overall system. Skilled artisans can implement the described functionality in varying ways for each particular application. Various components and blocks can be arranged differently (for example, arranged in a different order, or partitioned in a different way) all without departing from the scope of the subject technology.

Moreover, in the drawings and specification, there have been disclosed embodiments of the inventions, and although specific terms are employed, the term are used in a descriptive sense only and not for purposes of limitation. For example, various computers, nodes, and servers have been described herein as single machines, but embodiments where the computers, nodes, and servers comprise a plurality of machines connected together is within the scope of the disclosure (e.g., in a parallel computing implementation or over the cloud). Moreover, the disclosure has been described in considerable detail with specific reference to these illustrated embodiments. It will be apparent, however, that various modifications and changes can be made within the spirit and scope of the disclosure as described in the foregoing specification, and such modifications and changes are to be considered equivalents and part of this disclosure.

We claim:

1. A method for updating a file stored in a clustered file system using a file system intended for standalone computers, the method comprising:
receiving a command to update a file;
writing the command to update the file to an operation log on a file system on a primary node, wherein the operation log tracks changes to one or more files;
transmitting the updated operation log to a secondary node to initiate performance of the received command by the secondary node; and
applying the requested changes to the file on the primary node.

2. The method of claim 1, wherein the command to update the file comprises a command to write a new file.

3. The method of claim 1, wherein the file system comprises at least one of a zettabyte file system (ZFS) and a Write Anywhere File Layout (WAFL).

4. The method of claim 1, wherein the primary and secondary nodes have different configurations of a plurality of storage devices.

5. The method of claim 4, wherein the configurations of the plurality of storage devices comprise ZFS storage pools (zpools).

6. A computer cluster comprising
an interface connecting a primary node and a secondary node, wherein each node is configured with a file system intended for standalone computers;
a primary node comprising
a first storage medium configured to store files and to store a first operation log, wherein the operation log tracks changes to one or more of the files; and
a processing unit configured to
receive a command to update a file;
write the command to update the file to the operation log;
transmit the updated operation log to a secondary node to initiate performance of the received command by the secondary node; and
apply the requested changes to the file; and
the secondary node comprising
a second storage medium configured to store files and to store a second operation log; and
a processing unit configured to
receive an operation log from the primary node; and
apply the requested changes to the file.

7. The computer cluster of claim 6, wherein the command to update the file comprises a command to write a new file.

8. The computer cluster of claim 6, wherein the file system comprises at least one of a zettabyte file system (ZFS) and a Write Anywhere File Layout (WAFL).

9. The computer cluster of claim 6, wherein the primary and secondary nodes have different configurations of a plurality of storage devices.

10. The computer cluster of claim 9, wherein the configurations of the plurality of storage devices comprise ZFS storage pools (zpools).

11. A non-transitory computer program product, tangibly embodied in a computer-readable medium, the computer program product including instructions operable to cause a data processing apparatus to
receive a command to update a file;
write the command to update the file to an operation log on a file system on a primary node, wherein the operation log tracks changes to one or more files;
transmit the updated operation log to a secondary node to initiate performance of the received command by the secondary node; and
apply the requested changes to the file on the primary node.

12. The non-transitory computer program product of claim 11, wherein the command to update the file comprises a command to write a new file.

13. The non-transitory computer program product of claim 11, wherein the file system comprises at least one of a zettabyte file system (ZFS) and a Write Anywhere File Layout (WAFL).

14. The non-transitory computer program product of claim 11, wherein the primary and secondary nodes have different configurations of a plurality of storage devices.

15. The non-transitory computer program product of claim 14, wherein the configurations of the plurality of storage devices comprise ZFS storage pools (zpools).

16. A plurality of computer clusters comprising
an interface connecting a plurality of computers, wherein the computers are configured as nodes in a plurality of computer clusters;
each computer in the plurality of computers comprising
a storage medium configured with a plurality of file systems to store files and to store an operation log, wherein the operation log tracks changes to one or more of the files; and
a processing unit configured to
receive a command to update a file;
if the computer is configured as a primary node,
write the command to update the file to the operation log;
transmit the updated operation log to a secondary node to initiate performance of the received command by the secondary node; and
apply the requested changes to the file;
otherwise,
receive an operation log from the primary node; and
apply the requested changes to the file.

17. The plurality of computer clusters of claim 16, wherein the command to update the file comprises a command to write a new file.

18. The plurality of computer clusters of claim 16, wherein the file system comprises at least one of a zettabyte file system (ZFS) and a Write Anywhere File Layout (WAFL).

19. The plurality of computer clusters of claim 16, wherein the primary and secondary nodes have different configurations of a plurality of storage devices.

20. The plurality of computer clusters of claim 19, wherein the configurations of the plurality of storage devices comprise ZFS storage pools (zpools).
